(19) United States
(12) Patent Application Publication
(10) Pub. No.: US 2012/0265454 A1
(43) Pub. Date: Oct. 18, 2012

(54) Method For Determining Flow Characteristics Of A Medium And Associated Apparatus

(76) Inventors: Wayne Rudd, Newcastle Upon Tyne (GB); Allison Mason, Ponteland (GB); Laurie Linnett, Dirleton (GB)

(21) Appl. No.: 13/386,775

(22) PCT Filed: Jul. 22, 2010
(86) PCT No.: PCT/GB2010/001387

§ 371 Date: Jun. 7, 2012

(30) Foreign Application Priority Data
Jul. 24, 2009 (GB) 0912893.5

(51) Int. Cl. G01F 1/66; G06F 19/00

(52) U.S. Cl. 702/48

(57) ABSTRACT

Apparatus and methods for determining flow characteristics (e.g. flow rate, direction of flow, mass flow rate, etc.) of a multi-layered medium are described, such as a multi-layered medium in a pipeline. Such a multi-layered medium may be considered to have a first layer and second layer and an interface region, wherein the interface region is defined between the first and second layers. In some examples, a flow characteristic can be determined by using the time of flight of advanced signal communicated in a particular manner across the medium with the time of flight of a retarded signal communicated in a different manner across the medium, such that it is possible to use the time of flights together with a static speed of the advanced and retarded signal in both the first and second layers and the location of the interface region in order to determine the flow characteristics of the medium.

### TECHNICAL FIELD

The invention relates to a method for determining flow characteristics of a medium, and associated apparatus. In particular, the invention relates to a method for determining flow characteristics, such as flow rate, mass flow rate, volumetric flow rate, slip conditions, etc., of a multi-layered medium in a conduit, tubular, container, pipeline, reservoir, or the like.

### BACKGROUND

In certain industries it is desirable to measure properties of a medium, such as properties of solids, liquids or gases (or combinations thereof). Such mediums may be provided in a container, pipeline, reservoir, conduit, or the like. An example of a medium might be a coolant in a cooling system conduit, or a flow of hydrocarbons in a transportation/production pipeline. In some instances, mediums can comprise two or more layers, each layer being a different density and/or different phase. Such mediums may be considered to be multi-layered.

An example of a multi-layered medium may be hydrocarbon gas and oil, provided in a pipeline, in which the gas and oil are provided as different layers due to the difference in their relative densities. In an alternative example of a multi-layered medium, a conduit comprising a deposited build-up of matter on the inner wall may be considered to be a first layer, while the material passing through the conduit may be considered to be a second layer of the multi-layer medium.

It can be desirable to make measurements to determine or estimate properties of mediums (multi-layered or otherwise), such as the flow rates, slip conditions, or the like. In some cases, signals can be propagated into the medium to determine a flow characteristic. An example may be the use of a propagating signal, whereby the determined change in speed of the signal from its static speed in the medium is related to a flow rate. However, such signals are only really useful when the medium is homogenous (i.e. is not layered). Furthermore, the determined flow rates, etc., can be inaccurate due to the fact that the static speed of the propagated signal needs to be known in the medium at that particular time. Such static speed is often approximated, or guessed, based on the medium in question, or secondary indicators, such as temperature.

In a multi-layered medium, one layer may have a different flow rate from another layer, and/or one layer may be flowing in a different direction from another layer. In each case, it can be difficult to determine accurately the flow characteristics of that multi-layered medium.

Inaccurate measurement can often be provided in the oil and gas exploration and production industry, such as when monitoring the fluid flow in a multi-fluid/multi-layered medium in a pipeline, which can result in serious processing hazards, and/or an undesirable increase in operational costs. Furthermore, existing methods of measurement typically require significant assumptions to be made concerning the flow. This often results in the generation of complex calculations due to these assumptions, requiring additional processing time.

### SUMMARY

According to a first aspect of the invention there is provided a method for determining flow characteristics of a multi-layered medium, the medium having a first layer and second layer and an interface region defined between the first layer and the second layer, the method comprising:
using a time of flight of an advanced signal having been communicated across an advanced transmission path through the first and second layer and the time of flight of a retarded signal having been communicated across a retarded transmission path through the first and second layer, together with a static speed of the advanced signal and retarded signal in both the first and second layers and the location of the interface region along both the advanced and retarded transmission paths in order to determine the flow characteristics of the medium, the time of flight of the advanced signal and the time of flight of the retarded signal being influenced differently by the flow characteristics of the medium.

The first and second layers may comprise adjacent layers. The first and second layers may be stratified, or substantially stratified. The first and second layers may be substantially continuously stratified such that said layers are of a substantially equivalent dimension in at least one direction, such as the direction of the interface region. The first and second layers may be discretely stratified. In this arrangement one of the first and second layer may be at least partially contained within the other of the first and second layer. For example, one of the first and second layers may comprise a bubble, core, slug, droplet, bead, ball or the like contained within the other of the first and second layer.

The interface region may comprise an interface layer, boundary layer or the like. The interface region may comprise a region of emulsion. The interface region may comprise a region of gas and liquid foam defined between the first and second layers.

The speed of the advanced signal may have been increased due to the flow characteristics of the medium, with respect to the static speed of the advanced signal. The speed of the retarded signal may have been reduced due to the flow characteristics of the medium, with respect to the static speed of the retarded signal. The static speed in this case may refer to the propagation speed of the signal through the medium when stationary.

The speed of the advanced signal and the retarded signal may have been reduced due to the flow characteristics of the medium, with respect to the respective static speeds of the advanced and retarded signals. In such cases, the speed of the retarded signal may have been reduced to a greater extent than the advanced signal. The speed of the advanced signal and the retarded signal may have been increased due to the flow characteristics of the medium, with respect to the respective static speeds of the advanced and retarded signals. In such cases, the speed of the advanced signal may have been increased to a greater extent than the retarded signal.

The speed of the advanced and/or retarded signal may be influenced to a greater extent by the flow characteristic of the first layer or the second layer.

The advanced transmission path and the retarded transmission path may pass through different, or substantially different, regions of the medium. The advanced transmission path and the retarded transmission path may pass through the same, similar, or substantially the same, region of the medium. The advanced signal and the retarded signal may have been communicated in different directions across the same, similar, or substantially the same, regions of the medium. The advanced transmission path and the retarded transmission path may be the same, with the advanced signal communicated in one direction and the retarded signal communicated in another direction, such as an opposite direction.

The time of flight of the advanced signal may be the same or less than the time of flight of the retarded signal. The time of flight of the retarded signal may be the same or greater than the time of flight of the advanced signal.

The first and/or second layer may be considered to have a direction of flow. The first and second layers may have different directions of flow. The flow may be considered to be in a particular direction because the mean of the flow is in a particular direction. The flow may be considered to be in a particular direction because the principal mass flow is in a particular direction. In some instances, the direction of flow of the first and/or second layer may be static. The direction of flow of the first and/or second layer may be the same, or similar, to the orientation of a conduit providing passage for the medium.

The advanced signal may have been communicated in a direction having a component in the same, or similar, direction as the direction of flow of the first and/or second layer. The retarded signal may have been communicated in a direction having a component in the opposite, or substantially opposite, direction to the direction of flow of the first and/or second layer. The component may be considered to be a vector component. That is to say that the advanced and retarded signals may be considered to have vector components in directions associated with the direction of flow.

The advanced signal and retarded signal may have been communicated at an angle with respect to the direction of flow, or mean flow, of the first layer and/or second layer. The advanced signal and retarded signal may have been communicated at an angle with respect to the perpendicular of the direction of flow, or mean flow, of the first layer and/or second layer. The advanced signal and retarded signal may have been communicated at an angle with respect to the orientation of a conduit providing passage for the medium. The advanced transmission path and/or the retarded transmission path may have an angle with respect to the flow, or perpendicular to the flow, mean flow or perpendicular to the mean flow, of the first layer and/or second layer. The advanced transmission path and/or the retarded transmission path may have an angle with respect to the orientation of a conduit providing passage for the medium. The angle may be an oblique angle. The angle may be 1 degree, 5 degrees, 10 degrees, 20 degrees, 45 degrees, 85 degrees, etc., or any angle therebetween.

The determined flow characteristic may comprise one or more of: the first and/or second layer flow rate; the first and/or second layer direction of flow; the first and/or second layer volumetric flow rate; the first and/or second layer mass flow rate, such as bulk mass flow rate; the first and/or second layer slip conditions.

The method may comprise determining one or more of: the volumetric flow rate; the mass flow rate, the direction of flow; the slip condition of the first and/or second layer by using the determined flow rate.

The determined flow characteristic may provide for determining that one of the first and second layer has no flow rate or direction of flow, or an insignificant flow rate (e.g. static, or almost static). The method may comprise determining that one or both of the first and second layers comprise a deposit, such as a deposited build-up, sludge, or the like. For example, the method may comprise determining the presence of build-up, or deposit, by using a determined flow rate.

The method may comprise determining the flow characteristics from two or more possible flow characteristics of the first and/or second layer. The method may comprise determining the flow characteristics to be those that are most similar between the first and second layer. The method may comprise determining the flow characteristics to be those that are most similar with previously determined flow characteristics for the first and/or second layer.

The method may comprise using the difference in time of flight of the advanced signal and the retarded signal.

The method may comprise determining the static speed of the advanced and/or retarded signal in one or both of the first and second layer. The advanced signal and the retarded signal may be of the same signal species. That is to say that the determined static speed of the advanced signal in one or both of the first and second layers may be considered the same as the static speed of the retarded signal in one or both of the first and second layers, and vice versa. The static speed of one or both of the advanced signal and the retarded signal may be considered to be the same in one or both of the first and second layers.

The method may comprise determining the static speed of the advanced signal and/or retarded signal in at least one of the first and second layer by using a time of flight of a first speed signal having been communicated across a first known speed distance in the medium together with a time of flight of a second speed signal having been communicated across a second known speed distance in the medium. The first known speed distance and the second known speed distance may differ.

The signal species of the advanced signal and/or retarded signal, and first and second speed signals may be the same, or similar (e.g. acoustic signals at the same, or similar, frequency). This may provide for determining the static speed of the advanced signal and/or the retarded signal in at least one of the first and second layer by using a determined static speed of the first and/or second speed signal.

The distance travelled by the first and second speed signals having been transmitted through the second layer may be similar, or roughly the same, so as to provide for determining the static speed of the advanced and/or retarded signals through the first layer. The distance travelled by the first and second speed signals having been transmitted through the first layer may be similar, or roughly the same, so as to provide for determining the static speed of the advanced and/or retarded signals through the second layer. The distance travelled by the first and second speed signals transmitted through the first layer may be the same so as to provide for determining the static speed of the advanced and/or retarded signals through the second layer. The distance travelled by the first and second speed signals having been transmitted through the second layer may be the same so as to provide for determining the static speed of the advanced and/or retarded signal through the first layer.

The method may comprise using the time of flight of a third speed signal having been transmitted across a third known speed distance through the first and second layers. The third speed signal may be of the same, or similar, signal species as the first and second speed signals (i.e. the same, or similar, as the advanced and/or retarded signal). The third known speed distance may differ from at least one of the first and second known speed distances.

The distance of at least two of the first, second and third speed signals transmitted through the second layer may be similar, or roughly the same. The distance of at least two of the first, second and third speed signals transmitted through the first layer may be similar, or roughly the same. The distance of at least two of the first, second and third speed signals transmitted through the second layer may the same. The distance of at least two of the first, second and third speed signals transmitted through the first layer may be the same. Such configurations may provide for determining the static speed of the advanced and/or retarded signals through one or both of the first layer and the second layer. The static speed of the advanced and/or retarded signals through the first and second layer may be determined at the same or similar time (e.g. simultaneously).

One or more of the first, second and third speed signals may be transmitted twice (or more) in order to provide for determining the static speed of the advanced and/or retarded signals. For example, the method may comprise transmitting a first speed signal and a second speed signal in order to determine the static speed of the advanced and/or retarded signal in one of the first and second layers, and transmitting the first speed signal and third speed signal in order to provide for determining the static speed of the advanced and/or retarded signals in the other of the first and second layers. That is to say that in some cases, the first speed signal may be transmitted twice. In some cases the time of flight of the first speed signal may be used twice.

The second and third known speed distances may be similar, roughly the same, or the same. The second and third known speed distances may be different. The first, second and third known speed distances may be different.

The method may comprise comparing the difference in the time of flight between particular speed signals (i.e. first, second, and/or third speed signals) in order to provide for determining the static speed of the advanced and/or retarded signals in at least one of the first and second layer. For example, the method may comprise comparing the difference in the time of flight between at least two of the first, second and third speed signals in order to provide for determining the static speed of the advanced and/or retarded signals in at least one of the first and second layers. The method may comprise determining the difference in the time of flight between at least two of the first, second and third speed signal in order to provide for determining the static speed in at least one of the first and second layer.

The determination of the static speed of one or both of the advanced and retarded signals may allow for calibration, such as self-calibration. The method may allow for continuous calibration.

The method may comprise determining the location of the interface region along the advanced transmission path. The method may comprise determining the location of the interface region along the retarded transmission path.

The method may comprise using a time of flight of an interface signal having been communicated across an interface transmission path of known distance passing through the first layer, second layer and the interface region. The time of flight of the interface signal may be used together with the speed, which may be the static speed, of the interface signal in the first layer and the speed, which may be the static speed, of the interface signal in the second layer in order to provide for determining the location of the interface region along the interface transmission path.

The interface signal may be of the same, or similar, signal species as the first, second and/or third speed signals. The interface signal may be of the same, or similar, signal species as the advanced and/or retarded signals. Therefore, the determined static speed of the advanced and/or retarded signals in the first and second layers can be considered as the static speed of the interface signal. The method may comprise determining the static speed of the interface signal by using the time of flight of two or more of the first, second, and third speed signals.

The location of the interface region along one or both of the advanced transmission path and retarded transmission path may be determinable from the location of the interface region along the interface transmission path. The location of the interface region along the interface transmission path may be used together with the angle at which the advanced and/or retarded signals are communicated with respect to one or more of: the direction of flow of the medium (or the perpendicular of flow); the direction of mean flow of the medium; the orientation of a conduit. This may provide the location of the interface region along one or both of the advanced transmission path and retarded transmission path.

The location of the interface region may be provided with respect to a location of receipt of the interface signal. The location of the interface region may be provided with respect to a location of transmission of the interface signal. The location of the interface region may be an approximate location. The location may be provided as a particular distance along one or more of the interface transmission path, advanced transmission path, or retarded transmission path.

Determining the location of the interface region may provide for determining the height, or hold-up, of at least one of the first and second layer. The height, or hold-up of at least one of the first and second layer may be determined by using the determined location of the interface region and the known distance of the interface transmission path. The height may be the height of at least one of the first and second layer in a conduit, container, pipeline, reservoir, tubular, or the like. Determining the location of the interface region may provide for determining the height of both the first and second layer (e.g. in a conduit, etc.).

The method may comprise receiving one, some or all signals, such as advanced signals, retarded signals, speed signals, or interface signals. The method may comprise transmitting one, some or all of the signals.

The method may comprise transmitting and/or receiving one, some or all of the signals across a conduit, container, reservoir, etc. The method may comprise transmitting one, some, or all of the signals across a conduit, container, reservoir, etc., and receiving reflected signals. The reflected signals may have been reflected from different regions of a conduit, container, reservoir, etc., such as an opposing side thereof.

Known distances (e.g. interface known distances, known speed distances, etc.) that are similar, or roughly the same, may include distances that are the same, or substantially the same. The known distances may comprise one or more measured known distances, estimated known distances, evaluated known distances, approximated known distances, or the like. Distances may include configured known distances. For example, distance may be configured a predetermined distance.

That is to say that, in some instances the distances may be measured prior, during, or after transmitting of at least one of the signals, or may be estimated, evaluated, or approximated. In further instances, the method may comprise using the time of flight of signals having been transmitted a configured distance. For example, movable/adjustable apparatus may provide a configured known distance.

The method may comprise using the time of flight of a signal having been communicated across one or more recesses so as to provide for different distances between the known distances. The one or more recesses may allow for differentiation between the known distances. The one or more recesses may be provided with a conduit, a pipeline, or the like. A common recess may provide for different distances between two or more known distances and one or more further known distances. That is to say that a common recess may provide for differentiating between two or more known distances and one or more further known distances.

One or more of the signals may be transmitted from transmitters implanted, submerged, immersed, embedded, etc., in the multi-layered medium (e.g. transmitters may be immersed in a multi-layered medium in a reservoir, or the like). That is to say that one or more of the signals may be transmitted and received (and/or reflected and received) from regions within a multi-layered medium, such as a medium in a conduit, container, reservoir, or the like.

Two or more of the signals may be transmitted simultaneously. The method may comprise transmitting two or more of the signals substantially simultaneously. The method may comprise transmitting two or more of the signals sequentially (e.g. differing by 1 μs, 1 ms, 1 sec, 1 minute, or any time interval therebetween).

The method may comprise determining one or more of the flow characteristics, static speed of the advanced and/or retarded signal species, and/or location of the interface region simultaneously, or substantially simultaneously.

A time of receipt of one or more signals may be used to provide for determining the time of flight. The method may comprise determining the time of flight from a time of receipt of one or more signals. The time of receipt may be considered to be the time of flight.

The time of flight of one or more of the signals may be used as the time of flight for one or more of the other signals. For example, the time of flight of the interface signal may also be used as the time of flight of the first speed signal, or the like. That is to say that one or more common signals may be used. For example one or more common signals may be used as two or more of the: advanced/retarded signals; speed signals; and/or interface signals. Two or more of the known speed distances, interface transmission paths, advanced transmission paths, and retarded transmission paths may be the same. For example, the first speed distance and the interface transmission path may be the same. In such cases, the same signal (and time of flight) may be used as the first speed signal and interface signal.

The signals may comprise one or more of: acoustic signals, such as ultrasonic signals; electromagnetic signals, such as radio frequency signals; optical signals, etc. The method may comprise using transducers configured to transmit one or more of: acoustic signals, such as ultrasonic signals; electromagnetic signals, such as radio frequency signals; optical signals, etc. The method may comprise using transducers configured to receive one or more of: acoustic signals, such as ultrasonic signals; electromagnetic signals, such as radio frequency signals; optical signals, etc. The method may comprise using transducers configured to transmit and receive such signals (so-called transceivers).

The method may comprise determining the flow characteristics, static speed of the advanced and/or retarded signals, and/or location of an interface region of the medium in a substantially horizontal conduit, such as a horizontal conduit (e.g. a horizontal pipeline). The method may comprise transmitting/receiving first, second or third speed signals, and/or interface signals substantially perpendicular to a plane of the interface region provided by adjacent first and second layers.

The method may comprise transmitting signals at a rate of 0.01, 0.1, 1, 10, 100, 1000, 10000, 100000, signals per second (i.e. Hz), or any number therebetween.

The method may comprise providing for transmitting one or more signals, determining time of flight of one or more signals and/or determining static speed and/or flow characteristics, and/or the location of an interface region remotely (e.g. remotely controlled at a distance from a conduit, etc., carrying the first and second layer).

For example, the method may use remote communication with a location, such as a conduit, etc., in order to provide the method. The remote communication may be wired, wireless, or combination thereof. Wireless communication may include be such as those provided by wireless communication (e.g. Radio Frequency, IEEE 802 family (e.g. WiFi, WiMax, etc.) and/or and mobile cellular communication (GSM, UMTS, LTE, etc.), BlueTooth, ZigBee, etc.).

The method may comprise accounting for a conduit's, container's, or the like, wall thickness when evaluating the flow characteristic of the medium (e.g. when determining the static speed of signals in at least one of a first and second layer in a multi-layer medium). The method may comprise accounting for a conduit's, etc., wall thickness by approximating/using the time of flight of a signal to pass through a wall of the conduit, etc.

The multi-layer medium may comprise a single phase. The multi-layer medium may comprise multiple phases. The multi-layer medium may comprise any one or combination of: solid, liquid and/or gas component phase. The first layer may comprise any one, or more, of solid, liquid or gas component phases. The first layer may comprise a single component phase. The first layer may comprise multiple component phases. The first layer may comprise different or the same component phases. The first layer may comprise water, oil, hydrocarbon gas, hydrates, asphaltenes, etc. The second layer may comprise any one, or more, of solid, liquid or gas component phases. The second layer may comprise a single component phase. The second layer may comprise multiple component phases. The second layer may comprise different or the same component phases. The second layer may comprise water, oil, hydrocarbon gas, hydrates, asphaltenes, etc.

The first layer and the second layer may comprise different or the same component phases.

At least one of the first and second layers may comprise two or more sub-layers, such as three, four, five, ten, twenty sub-layers, or any number therebetween. Each sub-layer may be adjacent, such as being adjacently stratified, or the like. Each sub-layer may be provided with a sub-interface region, such as a region of emulsion, foam, etc. The flow characteristic of a layer comprising sub-layers may be determined to be the average flow characteristics of the cumulative sub-layers. IN some embodiments the present invention may be configured to determine one or more characteristics of one or more sub-layers

The method may comprise determining the flow characteristics of a medium in a conduit. The method may comprise using the time of flight of two or more signals having been communicated across a conduit. The conduit may comprise a pipeline, such as an oil and gas pipeline (e.g. production and/or exploration pipeline). The method may comprise using the time of flight of two or more signals having been communicated across transmission paths of a conduit at different interval orientations. For example, transmission paths spaced at every 30 degrees, 45 degrees, around a conduit, and/or 0.1 m, 0.2 m, etc. along a conduit, or the like. The intervals may be regular or irregular, or combination of regular and irregular intervals.

According to a second aspect of the invention there is provided a method for determining flow characteristics of a multi-layered medium, the medium having a first layer and second layer and an interface region defined between the first and second layers, the method comprising:
communicating an advanced signal across an advanced transmission path through the first and second layer, and determining the time of flight;
communicating a retarded signal across a retarded transmission path through the first and second layer, and determining the time of flight, the time of flight of the advanced signal and the time of flight of the retarded signal being influenced differently by the flow characteristics of the medium;
using the determined time of flight of the advanced signal and the time of flight of the retarded signal together with a static speed of the advanced signal and retarded signal in both the first and second layers and the location of the interface region along both the advanced and retarded transmission paths in order to determine the flow characteristics of the medium.

The method may comprise:
communicating an interface signal across an interface transmission path and determining the time of flight, the interface transmission path of known distance and passing through the first and second layer;
using the time of flight of the interface signal, the known distance, and the static speed of the interface signal in the first and second layer in order to provide the location of the interface region along both the advanced and retarded transmission paths.

The location of the interface region along both the advanced and retarded transmission paths may be provided by determining the location of the interface region along the interface transmission path.

The method may comprise:
communicating a first speed signal across a first known speed distance in the medium through the first and second layer, and determining the time of flight;
communicating a second speed signal across a second known speed distance in the medium through the first and second layer, and determining the time of flight, wherein the first known speed distance and the second known speed distance differ and the first and second speed signal are the same signal species as the advanced and/or retarded signals;
using the time of flight of the first speed signal, the second speed signal, and the first and second known speed distances in order to determine the speed of the advanced and/or retarded signal in one of the first and second layer.

The distance that the first and second speed signals are communicated through the second layer may be similar, or roughly the same, so as to provide for determining the static speed of the signal species through the first layer. The distance that the first and second speed signals are communicated through the first layer may be similar, or roughly the same, so as to provide for determining the static speed of the signal species through the second layer. The distance that the first and second speed signals are communicated through the first layer may be the same so as to provide for determining the static speed of the signal species through the second layer. The distance that the first and second speed signals are communicated through the second layer may be the same so as to provide for determining the speed of the signal species through the first layer.

The method may comprise communicating a third speed signal across a third known speed distance through the first and second layers, and determining the time of flight, in order to determine the static speed of advanced and/or retarded signal. The third speed signal may be of the same, or similar, signal species as the first and second speed signals (i.e. the same, or similar, as the advanced and/or retarded signal). The third known speed distance may differ from at least one of the first and second known speed distances.

The use of the first, second and third speed signals may be used to determine the static speed of the advanced and retarded signals in both the first and second layers, such as simultaneously.

The static speed of the advanced and/or retarded signals may be considered to be the static speed of the interface signal. The static speed of the advanced and/or retarded signal may be the static speed of the interface signal (i.e. the interface signals is the same, or similar, signal species as the advanced and/or retarded signal).

According to a third aspect of the invention there is provided apparatus for determining flow characteristics of a multi-layered medium, such a medium having a first layer and second layer and an interface region defined between the first and second layers, the apparatus configured to use a time of flight of an advanced signal having been communicated across an advanced transmission path through the first and second layer and the time of flight of a retarded signal having been communicated across a retarded transmission path through a first and second layer, together with a static speed of an advanced signal and retarded signal in both first and second layers and a location of an interface region along both the advanced and retarded transmission paths in order to determine the flow characteristics of a medium, the time of flight of an advanced signal and the time of flight of a retarded signal being influenced differently by the flow characteristics of a medium.

According to a fourth aspect of the invention there is provided apparatus for determining flow characteristics of a multi-layered medium, such a medium having a first layer and second layer and an interface region defined between a first and second layers, the apparatus comprising:
an advanced signal receiver configured to receive an advanced signal having been communicated across an advanced transmission path through a first and second layer, the advanced signal receiver configured to provide for determining the time of flight of an advanced signal;
a retarded signal receiver configured to receive a retarded signal having been communicated across a retarded transmission path through the first and second layer, the retarded signal receiver configured to provide for determining the time of flight of a retarded signal, the time of flight of an advanced signal and the time of flight of an retarded signal being influenced differently by the flow characteristics of a medium;
wherein the apparatus is configured to use a determined time of flight of an advanced signal and a determined time of flight of a retarded signal together with a static speed of an advanced signal and retarded signal in both a first and second layers and a location of an interface region along both the advanced and retarded transmission paths in order to determine the flow characteristics of a medium.

The apparatus may further comprise an advanced signal transmitter configured to transmit an advanced signal across an advanced transmission path through a first and second layer. The apparatus may further comprise a retarded signal transmitter configured to transmit a retarded signal across a retarded transmission path through a first and second layer.

The apparatus may comprise one or more transceivers. One or more transceivers may be used to transmit and receive advanced and/or retarded signals.

The apparatus may comprise an interface signal receiver. The interface signal receiver may be configured to receiver an interface signal having been communicated across an interface transmission path of known distance passing through the first and second layer. The interface signal receiver may be configured to provide for determining the time of flight of an interface signal.

The apparatus may comprise an interface signal transmitter. The interface signal transmitter may be configured to transmit an interface signal across an interface transmission path of known distance passing through the first and second layer.

The apparatus may be configured to determine the location of an interface region along the interface transmission path by using the time of light of an interface signal, the known distance of the interface transmission path, and the static speed of the interface signal in the first and second layer. The apparatus may be configured to determine the location of an interface region along one or both of the advanced and retarded transmission paths by using the determined location of the interface region along the interface transmission path.

The apparatus may comprise a first speed signal receiver, configured to receive a first speed signal having been communicating across a first known speed distance through a first and second layer in a medium. The first speed signal receiver may be configured to provide for determining the time of flight of a first speed signal.

The apparatus may comprise a second speed signal receiver, configured to receive a second speed signal having been communicating across a second known speed distance through a first and second layer in a medium. The second speed signal receiver may be configured to provide for determining the time of flight of a first speed signal.

The first known speed distance and the second known speed distance may differ. The first and second speed signal may be the same signal species as the advanced and/or retarded signals.

The apparatus may be configured to use a time of flight of a first speed signal, a second speed signal, and the first and second known speed distances in order to determine the speed of an advanced and/or retarded signal in one of a first and second layer.

The apparatus may comprise a first and/or second speed signal transmitter, configured to transmit a first and/or second speed signal.

The distance that the first and second speed signals are communicated through the second layer may be similar, or roughly the same, so as to provide for determining the static speed of the signal species through the first layer. The distance that the first and second speed signals are communicated through the first layer may be similar, or roughly the same, so as to provide for determining the static speed of the signal species through the second layer. The distance that the first and second speed signals are communicated through the first layer may be the same so as to provide for determining the static speed of the signal species through the second layer. The distance that the first and second speed signals are communicated through the second layer may be the same so as to provide for determining the speed of the signal species through the first layer.

The apparatus may comprise a third speed signal receiver, configured to receive a third speed signal having been communicating across a third known speed distance through a first and second layer in a medium. The third speed signal receiver may be configured to provide for determining the time of flight of a third speed signal. The apparatus may comprise a third speed signal transmitter, configured to transmit a third speed signal.

The apparatus may be configured to communicate a third speed signal across a third known speed distance through the first and second layers, and determine the time of flight, in order to determine the static speed of the advanced and/or retarded signal. The third speed signal may be of the same, or similar, signal species as the first and second speed signals (i.e. the same, or similar, as the advanced and/or retarded signal). The third known speed distance may differ from at least one of the first and second known speed distances.

The use of the first, second and third speed signals may be used to determine the static speed of the advanced and retarded signals in both the first and second layers, such as simultaneously.

The static speed of the advanced and/or retarded signals may be considered to be the static speed of an interface signal. The static speed of the advanced and/or retarded signal may be the static speed of the interface signal (i.e. the interface signals are the same, or similar, signal species as the advanced and/or retarded signal).

One or more of the advanced, retarded, interface and speed receivers may be additionally used to receive an advanced, retarded, interface or speed signal. That is to say that one or more of the advanced, retarded, interface and speed receivers may be used as a different receiver (e.g. a speed receiver may also be used as an interface signal receiver).

The apparatus may be configured to calibrate, or self-calibrate for the speed of advanced and/or retarded signals. For example, the apparatus may be configured to determine the static speed of the advanced and/or retarded signals for each measurement of the flow characteristics (and/or location of interface region). The apparatus may be configured to determine the static speed of the advanced and/or retarded signals for some measurements of the flow characteristics. Therefore, on some occasions a previously determined static speed of the advanced and/or retarded signal may be used.

The apparatus may comprise one or more recesses. The one or more recesses may provide for different distances between the known distances (e.g. the known distance of the interface transmission paths, and/or the known speed distances). The one or more recesses may be provided with a conduit, pipeline, container, reservoir, or the like. A common recess may provide for different distances between two or more known distances and one or more further known distances.

The apparatus may be comprised with a conduit, container, pipeline, or the like. The apparatus may be attachable/detachable with a conduit, container, pipeline, etc. The apparatus may be mountable/demountable with a conduit, container, pipeline, etc. The apparatus may be configured for attachment/mounting with the outer side of a conduit, container, pipeline, and/or the inner side of a conduit, pipeline, container, etc. The apparatus may be configured to be retro-fitted to a conduit, container, pipeline, etc. The apparatus may be provided with a conduit for use as a modular component of a pipeline, and/or further conduit. For example, the apparatus may be comprised with a portion of pipeline, conduit, flow circuit, or the like, for use with other modular parts of a pipeline, conduit, etc. Such other modular parts may not comprise apparatus, but merely act to complete a flow circuit, or the like.

The apparatus may be configured such that one, some or all of the signals may be transmitted through some, or all, of the first and second layer. For example, the apparatus may be configured such that one, some or all of the signals may be transmitted through, or across, a conduit, container, reservoir, or the like, comprising a multi-layered medium.

The apparatus may be configured such that one, some or all of the signals may be transmitted and received at differing regions of a conduit, container, reservoir, etc., such as opposing sides, or the like. One, some or all of the signals may be transmitted and received at opposing sides of a conduit, container, reservoir, etc., such as diametrically opposing sides. The apparatus may be configured to transmit and receive one, some or all of the signals across a conduit, container, reservoir, etc., such that the signals are transmitted and received at the same side of a conduit, container, reservoir, etc. The apparatus may be configured to transmit one, some, or all of the signals across a conduit, container, reservoir, etc., and receive reflected signals. The reflected signals may have been reflected from different regions of the apparatus, conduit, container, reservoir, etc., such as an opposing side thereof.

The apparatus may be configured such that one or more signals may be transmitted from transmitters implanted, or embedded, in the multi-layered medium, which may be a multi-layered medium in a conduit, reservoir, pipeline, etc. That is to say that the apparatus may be configured such that one or more signals might be transmitted and received (and/or reflected and received) from regions within a medium, such as a medium in a conduit, pipeline, reservoir, or the like. The apparatus may comprise one or more locators to allow location of the apparatus within a medium.

The apparatus may be configured such that two or more of the signals may be transmitted simultaneously, substantially simultaneously, or the like. The apparatus may be configured to transmit two or more of the signals sequentially (e.g. differing by 1 μs, 1 ms, 1 sec, 1 minute, or any time interval therebetween). The apparatus may be configured to evaluate the speed of a signal species in the first and second layers of the medium simultaneously, or substantially simultaneously.

The signal species may comprise one or more of acoustic signals, such as ultrasonic signals; electromagnetic signals, such as radio frequency signals; optical signals, etc.

The apparatus may comprise transducers configured to transmit one or more of: acoustic signals, such as ultrasonic signals; electromagnetic signals, such as radio frequency signals; optical signals, etc. The apparatus may comprise transducers configured to receive one or more of: acoustic signals, such as ultrasonic signals; electromagnetic signals, such as radio frequency signals; optical signals, etc. The apparatus may comprise transducers configured to transmit and receive such signals (so-called transceivers).

The apparatus may be configured to determine the flow characteristics in a medium in a substantially horizontal conduit, such as a horizontal conduit (e.g. a horizontal pipeline).

The apparatus may be configured to transmit signals at a rate of 0.01, 0.1, 1, 10, 100, 1000, 10000 signals per second (i.e. Hz), or any number therebetween.

The apparatus may be configured to provide for transmitting a signal, determining a time of flight of a signal and/or evaluating the speed of a signal remotely (e.g. remotely controlled at a distance from a conduit, etc., carrying the first and second layer).

According to a fifth aspect there is provided a flow characterisation device, comprising any of the features of the third or fourth aspects.

The flow characterisation device may be flow meter. The device may be provided with a pipeline, or portion of pipeline. The device may be an oil and gas device, such an oil and gas flow meter. The flow meter may be considered a multi-phase flow meter.

According to a sixth aspect there is provided a computer program, provided, or providable, on a computer readable medium, the computer program configured to provide the method according to the first or second aspect.

In certain aspects, the method/apparatus may be for determining the flow characteristics of a medium. The method/apparatus may be for use with measurement of mediums, such as fluids and/or deposits, in the oil and gas production/exploration/transportation industry, such as in pipelines and/or tubings associated with oil and gas production/exploration.

The invention according to the various aspects defined herein may be configured for use in determining the flow characteristics in more than two layers of a multi-layer medium.

The invention includes one or more corresponding aspects, embodiments or features in isolation or in various combinations with of aspects whether or not specifically stated (including claimed) in that combination or in isolation. For example, features of the first aspect may be equally applicable with the third or fourth aspect, and vice versa.

It will be appreciated that one or more embodiments/features/aspects may be useful in determining the flow characteristics of a medium, such as a multi-layered medium.

The above summary is intended to be merely exemplary and non-limiting.

### BRIEF DESCRIPTION OF THE FIGURES

These and other aspects of the invention will now be described, by way of example only, with reference to the accompanying drawings, in which:

FIG. 1 shows exemplary embodiments of apparatus for determining the flow characteristics of a first and second layer in a multi-layer medium;

FIG. 2 shows exemplary apparatus for determining the location of an interface region for use with the apparatus of FIG. 1;

FIG. 3 shows exemplary apparatus for determining the location of an interface region and the flow characteristics of a medium;

FIG. 4 shows embodiments of apparatus for determining the static speed of a signal species in a first/second layer for use with the apparatus of FIG. 1;

FIG. 5 shows further embodiments, comprising a conduit, of apparatus for determining the speed of a signal species in a first/second layer;

FIG. 6 shows apparatus for determining the flow characteristics of a medium;

FIG. 7 shows apparatus for determining the flow characteristics for use with multiple transmitters/receivers (or transceivers); and

FIG. 8 is a diagrammatic representation of the arrangement of layers within a conduit.

### DETAILED DESCRIPTION OF THE FIGURES

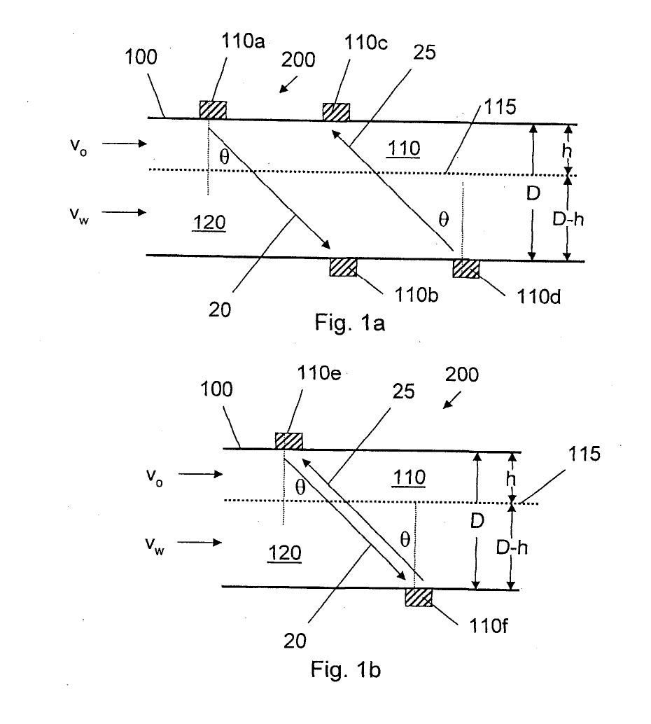

FIG. 1 shows a section of an exemplary conduit 100, comprising a multi-layer medium having a first layer 110 and a second layer 120. Here, the first layer 110 is adjacent the second layer 120 by means of an interface region 115. That is to say that the interface region 115 is defined between the first layer 110 and the second layer 120.

The conduit 100 is orientated in a horizontal configuration, such that the first layer 110 rests on the second layer 120. Here, the first layer 110 is a liquid hydrocarbon, such as oil, while the second layer 120 is water. Alternatively, the first and/or second layer may comprise any liquid, gas or solid (e.g. the first layer 110 may be a mixture water and oil in an emulsion, while the second layer may be asphaltene, such as an asphaltene deposit, or the like).

Here, the first layer 110 is defined by a first fluid, and the second layer 120 is defined by a second fluid. Therefore, the medium in this case has flow characteristics related to the flow characteristics of each of the first and second layer 110, 120, such as the direction of flow, the flow rate, mass flow rate, volumetric flow rate, slip conditions, and the like.

In this example, the first and second layer 110, 120 each have a flow rate, vₒ and v_{w}, in a particular direction, and can be considered to have a laminar or stratified flow. In this instance both the first and second layer 110, 120 have a flow rate in the same direction, but that need not always be the case. In some configurations, the first and second layer 110, 120 may have flow rates in different directions.

The conduit 100 shown in FIG. 1 is provided with a cross-sectional distance, ‘D’. The height, or so-called hold-up, of the first layer 110 can be considered to be ‘h’. The height, or so-called hold-up, of the second layer 120 can be considered to be ‘D-h’.

FIG. 1 further shows apparatus 200 according to an embodiment of the invention. The apparatus 200 comprises an advanced signal transmitter 110a and an advanced signal receiver 110b, and a retarded signal transmitter 110c and retarded signal receiver 110d.

The advanced signal transmitter 110a and advanced signal receiver 110b are configured to transmit and receive respectively an advanced signal of a particular signal species across an advanced transmission path 20 across the medium. Here, the advanced transmission path 20 is provided such that the speed of an advanced signal is increased due to the flow characteristics of the medium, with respect to the static speed of the advanced signal. Here, the advanced transmission path 20 is provided at an angle θ with respect to the perpendicular of the direction of flow of the first and second layer 110, 120. In other words, the advanced transmission path 20 is provided at an angle θ with respect to the cross section of the conduit 100.

The retarded signal transmitter 110d and retarded signal receiver 110c are configured to transmit and receive respectively a retarded signal of a particular signal species across a retarded transmission path 25 across the medium. Here, the retarded transmission path 25 is provided such that the speed of the retarded signal is decreased due to the flow characteristics of the medium, with respect to the static speed of the retarded signal. Here, the retarded transmission path 25 is provided at the same angle with respect to the perpendicular of the flow.

Similarly, the retarded transmission path 20 is provided at an angle θ with respect to the perpendicular of the direction of flow of the first and second layer 110, 120 (or provided at an angle θ with respect to the cross section of the conduit 100). In this example, the angle θ at which the advanced and retarded transmission paths are provided is the same, but in other embodiments that needs not be the case.

Because the advanced and retarded signals are communicated at an angle θ with respect to the direction of flow, they can be considered to have a component of direction associated with the direction of flow. That is to say that they can be considered to have a vector component associated with the direction of flow. The advanced signal has a component of direction in the same direction as the direction of flow. The retarded signal has a component of direction in the opposite direction to the direction of flow.

It will be appreciated that the static speed of the advanced and/or retarded signal is the speed that that signal would travel or propagate through a stationary, or static medium (or layer). Or put differently, the static speed can be considered to be the speed of the advanced or retarded signal having no, or an insignificant, component of direction, in the direction of flow of the first and/or second layer 110, 120 (e.g. perpendicular to the direction of flow of the first and/or second layer).

Each transmitter 110a, 110d and receiver 110b, 110c is configured to transmit and receiver ultrasonic signal species. Here, the apparatus 200 is configured to emit and receive uniquely identifiable ultrasonic signals so that there is the reduced chance of crosstalk between non-corresponding transmitters/receivers. The identifiable signals have a unique modulation so as to be uniquely identifiable, such as a unique amplitude modulation. The apparatus 200 is configured to evaluate the time of flight of the advanced signal and the retarded signal travelling across the advanced transmission path 20 and retarded transmission path 25 respectively.

Here, the apparatus 200 is configured to be mountable/demountable with the conduit 100, but in alternative configurations the apparatus 200 may be comprised with the conduit 100, or portion of the conduit, or the like. In some examples, the apparatus 200 is comprised with the conduit 100 (e.g. in a complete manner). Such a conduit 100 serves to define a passage for the medium, when the conduit 100 is then comprised with further pipeline, or the like.

The time of flight, tₐ, of an advanced signal travelling across the advanced transmission path 20 can be considered to be the cumulative time of flight, tₐ, of the advanced signal passing through the first layer 110, and then the second layer 120. This can be represented algebraically by the following:

$${t}_{a} = \frac{\frac{h}{cos θ}}{{V}_{o} + {v}_{o} sin θ} + \frac{\frac{( D - h )}{cos θ}}{{V}_{w} + {v}_{w} sin θ} \qquad ( 1 )$$

where Vₒ and V_{w} are the static velocities of the advanced signal in the first and second layers 110, 120. Here, the location of the interface region 115, or length of the first layer through which the advanced or retarded signal is communicated, is determined from the angle θ at which the respective signal is communicated and the height, h, or hold-up of the interface region 115 across the cross-section, D (e.g. using a trigonometric relationship). This is similar for the length of the second layer through which the advanced or retarded signal is communicated.

Of course, in alternative analysis, this may be presented as the location of the interface region 115, for example along the advanced and/or retarded transmission path, rather than using the angle, θ and the hold-up, h.

In a similar manner to above, the time of flight, tᵣ, of the retarded signal travelling across the retarded transmission path 25 can be considered to be the cumulative time of flight, t_{f}, of the retarded signal passing through the second layer 120, and then the first layer 110. This can be represented algebraically by the following:

$${t}_{f} = \frac{\frac{h}{cos θ}}{{V}_{o} - {v}_{o} sin θ} + \frac{\frac{( D - h )}{cos θ}}{{V}_{w} - {v}_{w} sin θ} \qquad ( 2 )$$

By expanding this further, equations (1) and (2) can be written as:

$$\begin{matrix}{t}_{a} = \frac{A + {Bv}_{w} + {Cv}_{o}}{D + {Ev}_{w} + {Fv}_{o} + {Gv}_{o} {v}_{w}} & ( 3 a ) \\ {t}_{r} = \frac{A - {Bv}_{w} - {Cv}_{o}}{D - {Ev}_{w} - {Fv}_{o} + {Gv}_{o} {v}_{w}} & ( 3 b )\end{matrix}$$

where:

$$A = \frac{{hV}_{w}}{cos θ} + \frac{( D - h ) {V}_{o}}{cos θ}$$

$$B = h tan θ$$

$$C = ( D - h ) tan θ$$

$$D = {V}_{o} {V}_{w}$$

$$E = {V}_{o} sin θ$$

$$F = {V}_{w} sin θ$$

$$G = {sin}^{2} θ$$

which in turn can be presented as:

v_{w}P+vₒQ+vₒv_{w}R=S (4a)

and

v_{w}T+vₒU+vₒv_{w}V=W (4b)

where:

P=Etₐ−B

Q=Ftₐ−C

R=Gtₐ

S=A−Dtₐ

T=−Etᵣ+B

U=−Ftᵣ+C

V=Gtᵣ

W=A−Dtᵣ

From equation (4a), we can re-arrange for vₒ:

$${v}_{o} = \frac{( S - {v}_{w} P )}{( Q + {v}_{w} R )} \qquad ( 5 )$$

and substitute this into equation (4b) to provide a quadratic for v_{w}

$${v}_{w} T + \frac{( S - {v}_{w} P )}{( Q + {v}_{w} R )} U + \frac{( S - {v}_{w} P )}{( Q + {v}_{w} R )} {v}_{w} V = W \qquad ( 6 )$$

This can then be solved for v_{w} and then vₒ by having a knowledge of: the time of flight of the advanced signal and retarded signal, the static speed of the advanced and retarded signals in the first layer Vₒ and in the second layer V_{w}; the location of the interface region along the advanced and retarded transmission paths 20, 25 (or the height or hold-up of the first/second layer, the cross-sectional distance, D, and the angle θ at which the advanced and retarded transmission paths 20, 25 provide with respect to the direction of flow, or perpendicular of the direction of flow).

Of course, it will readily be appreciated that the angle θ at which the advanced and/or retarded transmission paths make with the direction of flow, or the orientation of the conduit 100, can be determined from the horizontal displacement of the transmitter 110a, 110d and receiver 110b, 110c and the vertical displacement (e.g. the cross sectional distance, D).

Consider the example when:
tₐ=71.412 μs
tᵣ=71.431 μs
Vₒ=1410 m/s
V_{w}=1450 m/s
h=30 mm
D=101.6 mm
Horizontal spacing between respective transmitters/receivers=15 mm

The angle θ of the advanced transmission path 20 and retarded transmission path 25 can be determined from the horizontal spacing between their respective transmitters 110a, 110c and receivers 110b, 110d and the cross section, D. Here, θ is determined to be 8.4 degrees.

As such, (and because the solution is quadratic) this gives:
v_{w}=1.000 m/s or 1.636 m/s

and
vₒ=2.000 m/s or 0.564 m/s

In this instance, the values that are closer together are determined as providing the flow rates (i.e. v_{w}=1.000 m/s and vₒ=2.000 m/s). In further examples, each determined flow rate might be calculated and observed over a period of time in order to provide the flow rate. That is to say that the flow rate showing the least variance from the previous determined flow rate is considered to be accurate.

It will be appreciated that from the flow rate, further information may be determined, such as mass flow rate, volumetric flow rate, slip conditions, or the like. Such further information may be determined by using one or more of: the density and/or temperature of the first and/or second layer, the hold-up, the cross-sectional area of the first and/second layer.

Of course, in the above example it is shown that two pairs of transmitters and receivers (110a, 110d and 110b, 110c) are used in order to provide the advanced and retarded transmission paths 20, 25. However, in further configurations that need not be necessary. For example, consider the example shown in FIG. 1b in which a first combined advanced and retarded signal transceiver 110e and a second combined advanced and retarded signal transceiver 110f are configured to communicate the advanced signal across the advanced transmission path 20, and the retarded signal across the retarded transmission path 25. Here, the first signal transceiver 110e communicates the advanced signal to the second signal transceiver 110f, and the second signal transceiver 110f communicates the retarded signal to the first signal transceiver 110e. That is to say that the advanced and retarded transmission paths 20, 25 are the same, but in opposite directions. This reduces the number of transducers, and in addition, is able to determine more accurately the flow characteristics because both transmission paths are at the same location in the medium.

FIG. 1c shows a further configuration provided with an advanced and retarded signal transmitter 110g, 110h and a common advanced and retarded signal receiver 110i. Again, the apparatus 200 is configured such that the advanced signal is communicated in a direction having a component in same the direction as the direction of flow of the first and second layers, while the retarded signal is communicated in a direction having a component in the opposite direction to the direction of flow.

Here, the apparatus 200 is configured to communicate an advanced signal from the advanced signal transmitter 110g to the common receiver 110i, and similarly a retarded signal from the retarded signal transmitter 110h to the common receiver 110i. The determination of the flow characteristics of the medium (e.g. the flow rate of the first and/or second layer) is provided by using a similar analysis to that described above.

While in the above example, it is assumed that the location of the interface region 115 is known (such as along the advanced/retarded transmission paths 20, 25, or across the cross-section, D), it will be appreciated that this need not always be the case. In some configurations the height, or hold-up of the first and second layer may not be known. In such configurations the location of the interface region may need to be determined in order to provide the flow characteristics of the medium (e.g. the flow rates of the first and second layers 110, 120).

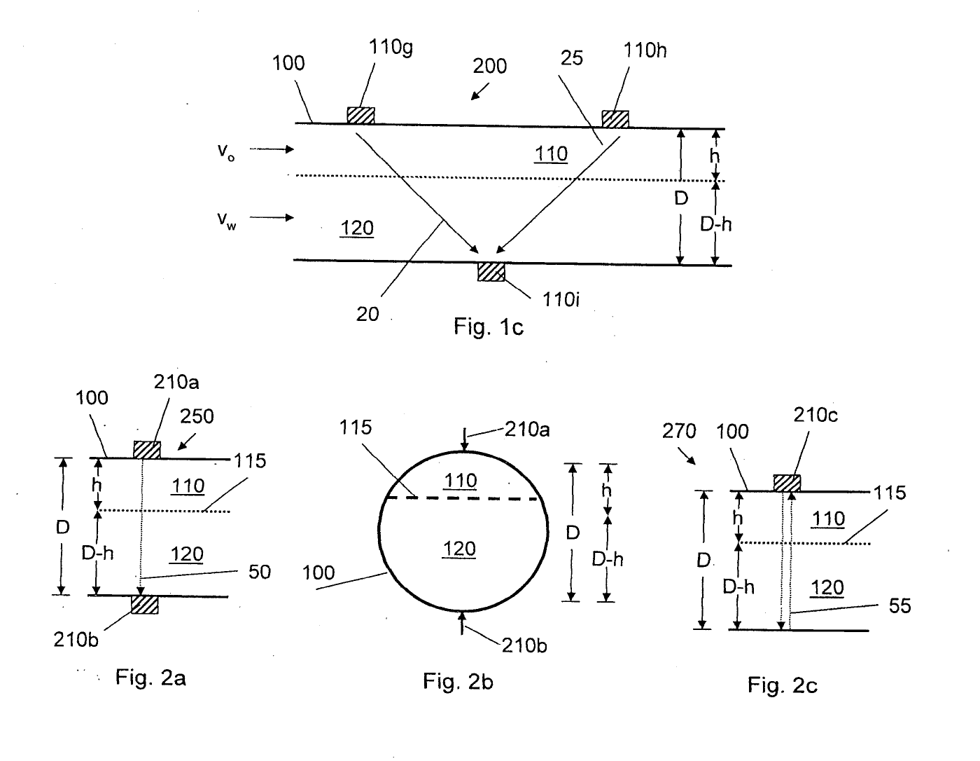

FIG. 2a shows a diagrammatic longitudinal section of the conduit 100 forming part of a pipeline, which comprises the multi-layer medium having the first layer 110 and the second layer 120 separated by the interface region 115. FIG. 2b shows a lateral cross-section of the exemplary conduit 100 as a tubular pipeline.

In a similar manner to that described in relation to FIG. 1, the conduit 100 is orientated in a horizontal configuration, such that the first layer 110 rests on the second layer 120. The distances D, D-h and h are the same as defined above.

FIG. 2a further shows apparatus 250 comprising an interface signal transmitter 210a and an interface signal receiver 210b. The interface signal transmitter 210a and interface signal receiver 210b are configured to transmit and receive respectively an interface signal of a particular signal species across an interface transmission path 50. Here, the interface transmission path 50 is provided across the known distance, ‘D’.

FIG. 2b shows the relative positions of the respective interface signal transmitter 210a and interface signal receiver 210b as indicated by arrows. Although shown such that the interface signal transmitter/receiver 210a, 210b are perpendicular to the interface region 115, in alternative embodiments that need not be the case. In this example however, the speed of the interface signal is not affected by the flow characteristics of the medium.

The apparatus 250 is configured such that the interface signal passes initially through the first layer 110, and then through the second layer 120 in order to reach the interface signal receiver 210b. The interface signal transmitter 210a is the distance ‘h’ from the interface region 115, while the interface signal receiver 210b is the distance ‘D-h’ from the interface region 115.

Here, the interface signal transmitter 210a and interface signal receiver 210b are configured to transmit and receive ultrasonic signal species in a similar manner to that described above. The apparatus 250 is configured to determine the time of flight of an interface signal travelling across the transmission path 50. The time of flight may be measured by observing the difference in time between transmitting an interface signal and receiving an interface signal. Alternatively, the apparatus 250 may be configured to only observe the time of receipt. In such cases, the time of flight may be determined from further information regarding the time of transmission.

In this example, the apparatus 250 is configured to be mountable/demountable with the conduit 100, however in alternative configurations the apparatus 250 may be comprised with the conduit 100, or portion of the conduit, or the like, in a similar manner to above.

It will be appreciated that the time of flight of the interface signal travelling across the transmission path 50 can be considered to be the cumulative time of flight of the interface signal passing through the first layer 110, and then the second layer 120. This can be represented algebraically by the following:

tᵢ=tₒ+t_{w} (7)

where tᵢ is the cumulative time of flight of an interface signal passing through the first layer 110 and through the second layer 120, (tₒ+t_{w}). Assuming an average velocity or speed of signal species in each layer 110, 120, the cumulative time of flight can be considered as:

$${t}_{i} = \frac{h}{{V}_{o}} + \frac{( D - h )}{{V}_{w}} \qquad ( 8 )$$

where Vₒ and V_{w} are the static speed of the interface signal species in the first layer 110 and the second layer 120 respectively. That is to say that in this example Vₒ is the static speed of the interface signal passing through oil, while V_{w} is the static speed of the interface signal passing through water.

Consider the situation as described above in relation to determining flow characteristics when:
D=101.6 mm
Vₒ=1410 m/s
V_{w}=1450 m/s
tᵢ=70.656 μs

By substituting these values into (8) it can be shown that,

$${t}_{i} = \frac{h}{{V}_{o}} + \frac{( D - h )}{{V}_{w}}$$

$$70.656 μ s = \frac{h}{1410 m \text{/} s} + \frac{( 101.6 mm - h )}{1450 m \text{/} s}$$

$$h = 30 mm$$

Therefore, it can be determined that the interface region is 30 mm from the interface signal transmitter 210a, and 71.6 mm from the interface signal receiver 210b. This determined height can be used with the angle θ, in order to provide a location of the interface region along either or both of the advanced transmission path 20 and retarded transmission path 25 (i.e. using trigonometric relationships)

FIG. 2c shows a further exemplary embodiment of apparatus 270, similar to that described in relation to FIGS. 2a and 2b. However, in this configuration, the apparatus 270 is provided with a combined interface signal transmitter and receiver 210c, which can be used to transmit and receive the interface signal (i.e. a transceiver) across a transmission path 55. In this case, the transmission path 55 is twice that of FIGS. 2a and 2b.

Following the similar analysis to above, it can be shown that the cumulative time of flight can be considered as:

$${t}_{i} = \frac{2 h}{{V}_{o}} + \frac{2 ( D - h )}{{V}_{w}} \qquad ( 9 )$$

Thus when:
D=101.6 mm
Vₒ=1410 m/s
V_{w}=1450 m/s
tᵢ=141.312 μs

By substituting these values into (9) it can be shown that again h is 30 mm. Again, this determined height can be used with the angle θ, in order to provide a location of the interface region along either or both of the advanced transmission path 20 and retarded transmission path 25.

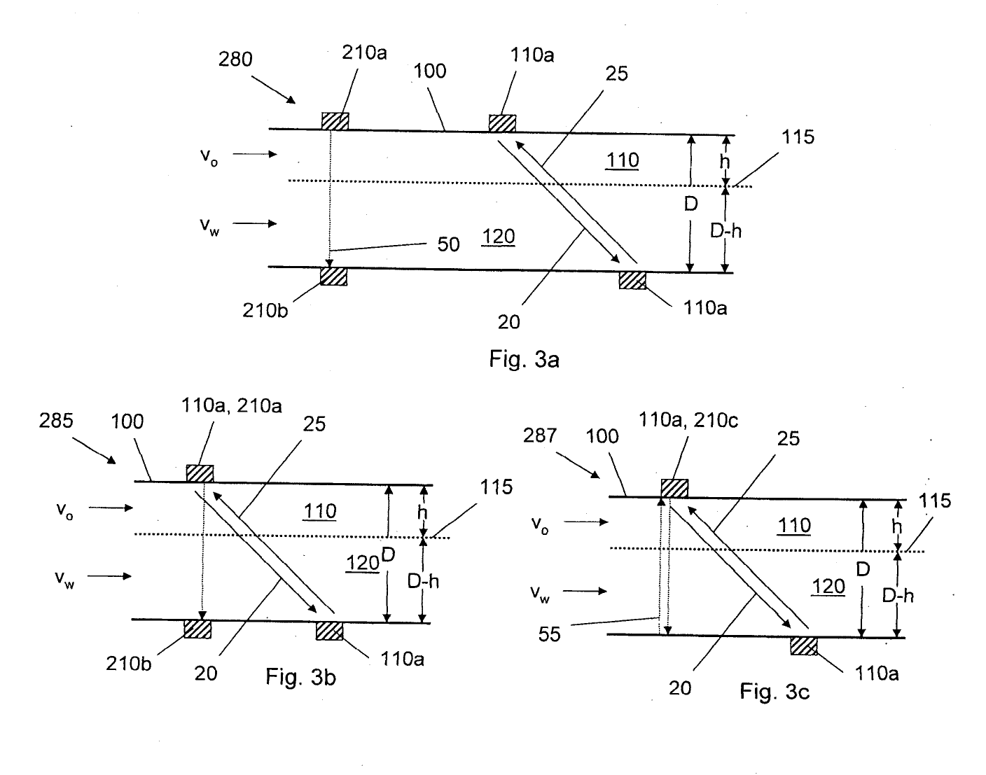

FIG. 3a shows an apparatus for determining the location of the interface region and the flow characteristics of a medium 280, as per FIG. 1b and FIG. 2a. Again, the first layer 110 and second layer 120 have a flow rate vₒ and v_{w}, in a particular directions. In this arrangement, the apparatus 280 is configured to transmit an advanced signal, retarded signal, and interface signal simultaneously. The determined time of flight of the interface signal provides the hold-up, h. Because the interface transmission path 50 passes perpendicular to the flow, the time of flight determined is unaffected, or is not significantly affected, by the flow characteristics of the medium (e.g. the flow rate of the first and/or second layer 110, 120). Of course, in alternative configurations, apparatus 200 for determining the flow characteristic of a medium, as per FIG. 1a or 1c may be used, or any further suitable arrangement.

The determined location of the interface region 115 can then be used with equations 4a and 4b (and the angle θ, or the displacement between respective transmitters/receivers) to provide the flow characteristics of the medium.

FIG. 3b shows a further configuration of apparatus 285 for determining the flow characteristic of a medium and for determining the location of an interface region 115. However, as is shown in FIG. 3b, a common transceiver 110a, 210a is used to transmit an advanced signal, receive a retarded signal, and transmit an interface signal. FIG. 3c shows a further configuration, similar to that described in relation to

FIG. 3b, but in which apparatus 287 for determining the location of an interface region 115 using a reflected interface signal across a reflected interface transmission path 55 is used (as per FIG. 2c).

Using the apparatus 280, 285, 287 as shown in FIG. 3, it is possible to simultaneously (or substantially simultaneously) determine the location of the interface region 115 and the flow characteristics of the medium. However, as is described above, this assumes that the static speed of the interface signal, advanced signal and retarded signal is known, or estimated, in the first and second layer.

It will readily be appreciated that this need not always be the case. In some instances, the static speed of the signals in the medium may vary depending upon the particular properties of the medium, such as density, temperature, etc. In addition, these properties may be time variant, thus the static speed may vary over a period of time. In some cases there is a need for self-calibration.

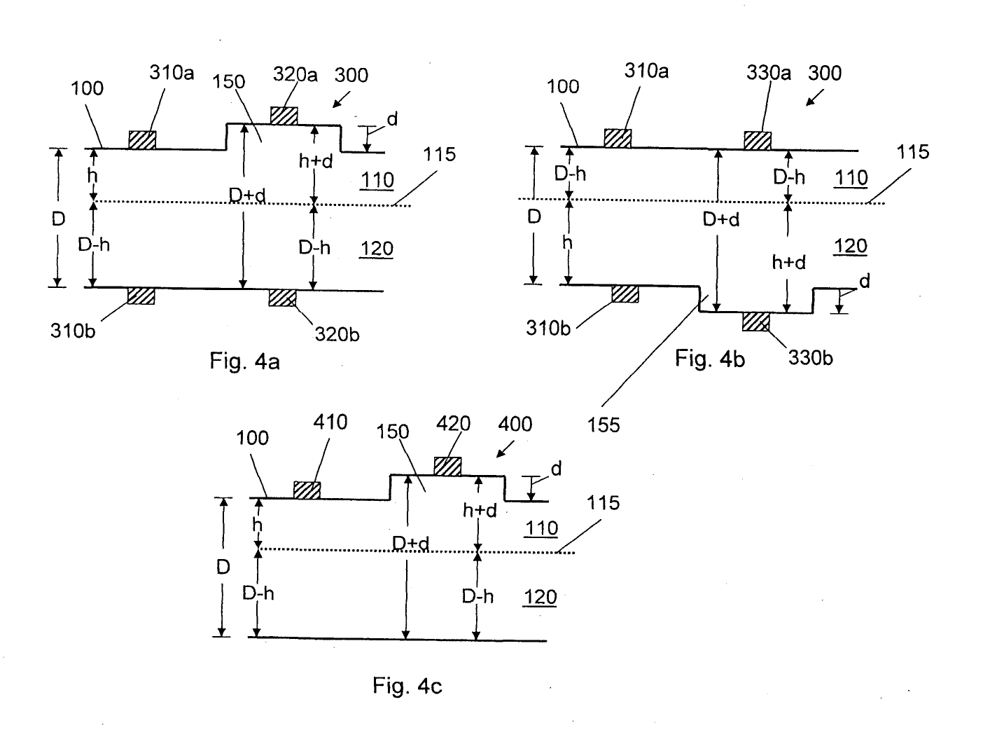

Consider FIG. 4, which shows a similar section of the exemplary conduit 100, comprising the multi-layer medium (i.e. first layer 110 and the second layer 120).

The conduit 100 shown in FIG. 4a is provided with a first known speed distance. The first known speed distance is the cross-sectional distance, ‘D’. The conduit 100 comprises a recess 150 having an effective distance, so as to provide a second known speed distance of the conduit 100. The second known speed distance is the second cross-sectional distance, ‘D+d’. That is to say that the second cross-sectional distance differs from the first cross-sectional distance by, ‘d’. Here, ‘d’ is comprised with the first layer 110.

The height of the first layer 110 at the first known speed distance can be considered to be ‘h’. The height of the second layer 120 at the first known speed distance can be considered to be ‘D-h’.

The height of the first layer 110 at the second known speed distance can be considered to be ‘h+d’, while the height of the second layer 120 at the second known speed distance can be considered to be ‘D-h’.

FIG. 4a further shows apparatus 300. The apparatus 300 comprises a first speed signal transmitter 310a and a first speed signal receiver 310b. The first speed signal transmitter 310a and first speed signal receiver 310b are configured to transmit and receive respectively a first speed signal of the same signal species as: the interface signal; the advanced signal; and the retarded signal. In this example, consider that all these signals are of the same signal species (e.g. ultrasonic signals). The first speed signal transmitter 310a and first speed signal receiver 310b are configured to transmit and receive respectively a first speed signal across the first known speed distance, D, of the conduit 100. The apparatus 300 is configured such that the first speed signal passes initially through the first layer 110, and then through the second layer 120 in order to reach the first receiver 310b.

The apparatus 300 further comprises a second speed signal transmitter 320a and a second speed signal receiver 320b. The second speed signal transmitter 320a and second receiver 320b are configured to transmit and receive respectively a second speed signal of the same signal species across the second known speed distance, D+d, of the conduit 100. Here, the second speed signal transmitter 320a is in communication with the recess 150 so as to communicate the second speed signal initially through the first layer 110, then through the second layer 120 so as to reach the second receiver 320b.

Again, the apparatus 300 is configured to emit and receive uniquely identifiable ultrasonic signals so that there is the reduced chance of crosstalk between non-corresponding transmitters/receivers. The identifiable signals have a unique modulation so as to be uniquely identifiable, such as a unique amplitude modulation. The apparatus 300 is configured to evaluate the time of flight of a first and second speed signal travelling across the first and second known speed distances. In the present embodiment, the first and second speed signals are transmitted simultaneously.

Again, the apparatus 300 is configured to be mountable/demountable with the conduit 100, but in alternative configurations the apparatus 300 may be comprised with the conduit 100, or portion of the conduit, or the like, in a similar manner to that described above.

It will be appreciated that the time of flight of the first speed signal travelling across the first known speed distance can be considered to be the cumulative time of flight of the first signal passing through the first layer 110, and then the second layer 120. This can be represented algebraically by the following:

t₁=tₒ+t_{w} (10)

where t₁ is the cumulative time of flight of a first signal passing through the first layer 110 and through the second layer 120, (tₒ+t_{w}). Assuming an average velocity or speed of signal species in each layer 110, 120, the cumulative time of flight can be considered as:

$${t}_{1} = \frac{h}{{V}_{o}} + \frac{( D - h )}{{V}_{w}} \qquad ( 11 )$$

where Vₒ and V_{w} are the static speed of the signal species in the first layer 110 and the second layer 120 respectively. These values are unknown and to be established.

In a similar manner, the cumulative time of flight of a second speed signal passing through the first layer 110, and then the second layer 120 can be considered to be:

$${t}_{2} = \frac{d + h}{{V}_{o}} + \frac{( D - h )}{{V}_{w}} \qquad ( 12 )$$

It will be readily appreciated that the above expressions apply whether or not the respective speed signals pass initially through the first layer 110, then through the second layer 120, or whether they pass initially through the second layer 120, then through the first layer 110; the time of flight remains the same.

By subtracting equation (12) from equation (11), the static speed of the signal species (i.e. the static speed of the interface/advanced/retarded signal) in the first layer 110 can be obtained, as will be exemplified by the following:

Consider the same situation as described above, when:
D=101.6 mm, and
d=2.0 mm,

Therefore, the first known speed distance and the second known speed distance can be determined. Assuming:
t₁=70.656 μs, and
t₂=72.074 μs.

t₂−t₁=72.074 μs−70.656 μs=1.418 μs

Therefore,

$$1.418 = [ \frac{d + h}{{V}_{o}} + \frac{( D - h )}{{V}_{w}} ] - [ \frac{h}{{V}_{o}} + \frac{( D - h )}{{V}_{w}} ]$$

$$1.418 = \frac{d + h}{{V}_{o}} + \frac{( D - h )}{{V}_{w}} - \frac{h}{{V}_{o}} - \frac{( D - h )}{{V}_{w}}$$

$$1.418 = \frac{d + h}{{V}_{o}} - \frac{h}{{V}_{o}}$$

$$1.418 {V}_{o} = d + h - h$$

$${V}_{o} = \frac{d}{1.418} = \frac{2 mm}{1.418 μs} = 1410 m \text{/} s$$

By evaluating accurately the speed of a signal species in the first layer 110, further measurements can then be made of the first layer 110, for example for use with one or more of the interface signal, advanced signal, and retarded signal. It is noted that in the above example, it is not necessary that the specific height ‘h’ of the first layer 110 be known in order to determine the speed of the signal species.

FIG. 4b shows a further embodiment, showing a further section of conduit 100, comprising the first layer 110 and the second layer 120, in a similar manner to that described above.

Again, the conduit 100 is provided with a first known speed distance, ‘D’, and a second known speed distance, ‘D+d’. However, ‘d’ is provided by the cross-sectional distance of a recess 155, comprised, in this embodiment, with the second layer 120.

For the following analysis, in this embodiment the height of the second layer 120 at the first known speed distance can be considered to be ‘h’, while the height of the first layer 110 at the first known speed distance can be considered to be ‘D-h’, and the height of the second layer 120 at the second known speed distance can be considered ‘h+d’, and the height of the first layer 110 at the second known speed distance can be considered ‘D-h’. As a result, a similar analysis can be performed as described above to derive the speed of a signal species in the second layer 120.

Again, apparatus 300 comprises a first speed signal transmitter 310a, first speed signal receiver 310b, second speed signal transmitter 330a, and second speed signal receiver 330b in a similar manner to that described above.

The following expressions are applicable:

$$\begin{matrix}{t}_{1} = \frac{( D - h )}{{V}_{o}} + \frac{h}{{V}_{w}} & ( 13 ) \\ {t}_{2} = \frac{( D - h )}{{V}_{o}} + \frac{d + h}{{V}_{w}} & ( 14 )\end{matrix}$$

Consider the situation when:
D=101.6 mm, and
d=2.0 mm,

Thus, the first known speed distance and the second known speed distance can be determined, and:
t₁=70.656 μs, and
t₂=72.035 μs.

It will readily be noted that in this instance t₁ is the same as that above, because the same signal has been passed through the same layer, while t₂ differs due to the fact that the recess 155 contains the material of the second layer 120 rather than the first layer 110.

t₂−t₁=72.035 μs−70.656 μs=1.379 μs

Therefore,

$$1.379 = [ \frac{( D - h )}{{V}_{o}} + \frac{d + h}{{V}_{w}} ] - [ \frac{( D - h )}{{V}_{o}} + \frac{h}{{V}_{w}} ]$$

$$1.379 = \frac{( D - h )}{{V}_{o}} + \frac{d + h}{{V}_{w}} - \frac{( D - h )}{{V}_{o}} - \frac{h}{{V}_{w}}$$

$${1.379}_{w} = d + h - h$$

$${V}_{w} = \frac{d}{1.379} = \frac{2 mm}{1.379 μs} = 1450 m \text{/} s$$

Thus, by using the apparatus configured as in FIG. 4a and FIG. 4b, the static speed of the signal species can be determined, which in this case is the speed of sound (the signals being ultrasonic). Using the apparatus 300 of FIGS. 4a and 4b it is then possible to determine the flow characteristics. It will be appreciated that the determined static speed may be used when determining the location of the interface region 115.

FIG. 4c shows a further embodiment of a conduit 100, comprising the first layer 110 and the second layer 120, and a recess 150, in a similar manner to that described in relation to FIG. 4a. The conduit 100 is further provided with apparatus 400 for determining the speed of a signal species in the first layer 110.

In this embodiment, the apparatus 400 comprises a first speed transceiver 410 configured to transmit a first speed signal across the distance, D, of the conduit 100, and to receive a reflected first speed signal, reflected from the other side of the conduit 100. That is to say that the first speed signal passes twice through the first layer 110 and second layer 120, and travels a distance of 2×D. In effect, the first known speed distance can be considered to be 2×D.

The apparatus 400 further comprises a second speed transceiver 420, configured to transmit a second speed signal across D+d, of the conduit 100, and receive a reflected second signal, reflected from the other side of the conduit 100. That is to say that the second speed signal passes twice through the first layer 110, second layer 120, and recess 150, and travels a distance of 2×(D+d). In effect, the second known speed distance can be considered to be 2×(D+d).

Following the similar analysis to above, it can be shown that:

$${V}_{o} = \frac{2 d}{{t}_{2} - {t}_{1}} \qquad ( 15 )$$

Following the above example, a skilled reader will readily be able to implement a similar configuration of FIG. 4b by using transceiver(s) for reflected signals, rather, or in addition to, transmitters/receivers 310a, 310b, 320a, 320b, 330a, 330b.

It will readily be appreciated that a combination of apparatus 300 shown in FIG. 4a and 4b (or 4c) provides for evaluating both the speed of a signal species in the first layer, Vₒ, and the speed of a signal species in the second layer, V_{w}.

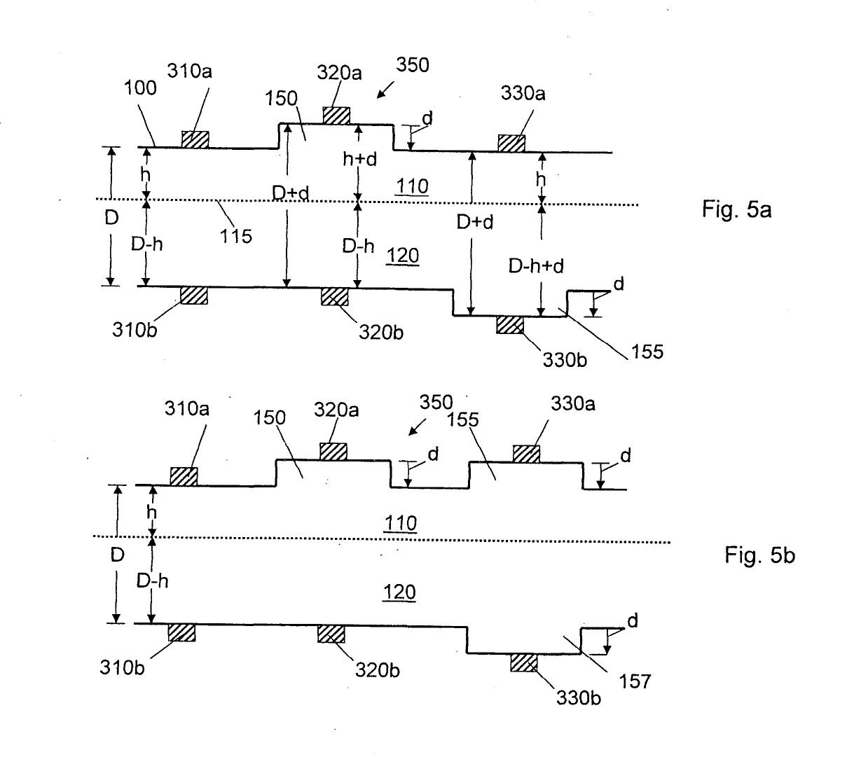

However, because t₁ is measured across the same distance, there is no requirement to provide a duplication of transmitter/receiver when combining the apparatus 300 of FIGS. 4a and 4b. FIG. 5a therefore shows a combined configuration of apparatus 350, which in this exemplary embodiment are provided for use with a conduit 100. Here, the first speed signal is the same as the first speed signal of FIG. 4a. Here, the apparatus is configured such that: a first speed signal is the same as the first speed signal of the embodiment shown in FIG. 4a; a second speed signal is the same as the second speed signal of the embodiment shown in FIG. 4a; and a third speed signal is the same as the second speed signal of the embodiment shown in FIG. 4b.

The apparatus 350 of FIG. 5 can be considered to have a first, second and third speed signal transmitter 310a, 320a, 330a, as well as a first, second and third speed signal receiver 310b, 320b, 330c.

The first, second, and third speed signals are transmitted simultaneously, each of which is uniquely identifiable (such as uniquely identifiable by using unique amplitude modulation). The time of flight of the first speed signal and the time of flight of the second speed signal can be used to evaluate the speed of a signal in the first layer 110, while the time of flight of the first signal and the time of flight of the third speed signal can be used to evaluate the speed of a signal in the second layer. In this case, there is provided a first, second, and third known speed distance.

In the above embodiments, the speed of the signal species may be used to determine the location of the interface region, and thus the flow characteristics.

In addition, the apparatus 350 may be configured to determine further measurement, characterisation, or analysis or the medium. For example, the apparatus 350 may be further configured to identify that the speed of an acoustic signal propagating in the first layer is roughly 300 m/s, and that, as a result, the first layer 110 is a hydrocarbon gas, rather than oil (e.g. by using look-up tables, and/or noting that oil has a far greater speed of sound). Additionally/alternatively, by having knowledge of the particular material of a particular layer (e.g. having determined that the first layer 110 is a hydrocarbon gas), it is possible to determine further material characteristics such as determining the temperature and/or density by using the evaluated speed of a signal species in that layer (e.g. again, by using look-up tables, or equations of state, etc.).

It will be appreciated that while in some embodiments the recesses 150, 155 might be comprised with a conduit 100 (as above), in other embodiments that need not be the case. The recesses 150, 155 may be provided by an additional element, configured to be placed on the conduit 100. In such cases, the recesses 150, 155 may comprise a material similar (or the same) as the particular layer 110, 120 (e.g. comprising oil, gas, or the like). In some cases, the recesses 150, 155 is provided by an attachable/detachable recess elements, having a containing portion for containing layer material (e.g. oil, gas, etc.) and configured to provide, when on the conduit, the second known speed distance. In such cases, the thickness of the walls of such a recesses element, and/or conduit can be configured to be insignificant with respect to the second known speed distance, or the apparatus 350 can be configured to compensate for the wall thickness (e.g. by having a prior knowledge of the thickness of the walls as the speed of a signal species through those walls).

It will readily be appreciated that the recesses 150, 155 may be provided by a region of differing cross-section of an existing conduit, or pipeline, and may be provided such that the second known speed distance is larger, or smaller, than the second known speed distance, as will be apparent. The recesses 150, 155 may be configured by casting, and/or machining, or the like.

It will also be readily appreciated that while in the above embodiments, ‘d’ is taken to be the same in the second and third known speed distances, that in other embodiments that need not be the case. For example, in some embodiments the distance provided by ‘d’ may differ. In some embodiments, ‘d’ may be selected dependent upon the layer with which the particular recess 150, 155 is to be in communication.

FIG. 5b shows a further embodiment in which the conduit 100 comprises the multi-layered medium having the first layer 110 and the second layer 120. Here, the conduit 100 is provided with apparatus 360 for determining the speed of a signal species in the first layer 110 and the second layer 120. The apparatus 360 is similar to that described in relation to FIG. 5a, and comprises the first, second and third speed signal transmitters 310a, 320a, 330a, and first, second and third speed signal receivers 310b, 320b, 330b. However, unlike FIG. 5a, the apparatus 360 of FIG. 5b has a further recess 157 to provide the third known speed distance. Recesses 155 and 157 are opposing.

The third speed signal transmitter 330a, and third speed signal receiver 330b therefore are configured to transmit/receive a third speed signal across a third known speed distance, D+2d, of the conduit 100, which includes the cross sectional distance of the conduit, ‘D’ and the cross-sectional distance of the two recesses 155, 157.

The following expressions can be established for the time of flight of respective signals being communicated between respective transmitters/receivers, where ‘h’ is the height of the first layer 110:

$$\begin{matrix}{t}_{1} = \frac{h}{{V}_{o}} + \frac{( D - h )}{{V}_{w}} & ( 16 ) \\ {t}_{2} = \frac{d + h}{{V}_{o}} + \frac{( D - h )}{{V}_{w}} & ( 17 ) \\ {t}_{3} = \frac{d + h}{{V}_{o}} + \frac{( D - h + d )}{{V}_{w}} & ( 18 )\end{matrix}$$

It will be noted the similarity of these equation to those presented previously. Therefore, in a similar manner to that described above, subtracting (16) from (17) provides for Vₒ.

To determine the speed of a signal species in the second layer 120, equation (17) is subtracted from equation (18) as follows:

$${t}_{3} - {t}_{s} = [ \frac{d + h}{{V}_{o}} + \frac{( D - h + d )}{{V}_{w}} ] - [ \frac{d + h}{{V}_{o}} + \frac{( D - h )}{{V}_{w}} ] \\ {t}_{3} - {t}_{s} = \frac{d + h}{{V}_{o}} + \frac{( D - h + d )}{{V}_{w}} - \frac{d + h}{{V}_{o}} - \frac{( D - h )}{{V}_{w}} \\ {V}_{w} = \frac{d}{( {t}_{3} - {t}_{s} )} \qquad ( 19 )$$

A skilled reader will readily appreciate that the embodiment shown in FIG. 5b may be use to simultaneously assess the static speed of signals in the first layer 110 and second layer 120.

While the apparatus 350, 360 in FIG. 5 has been presented as being able to determine the static speed of signal in both the first and second layers 110, 120, it will be appreciated that the apparatus 350, 360 may additionally be used to determine the location of the interface region and/or the flow characteristics of the medium. That is to say that the configuration of the transmitters/receivers, may be used additionally to determine the location of the interface region 115 and the flow characteristics of the medium.

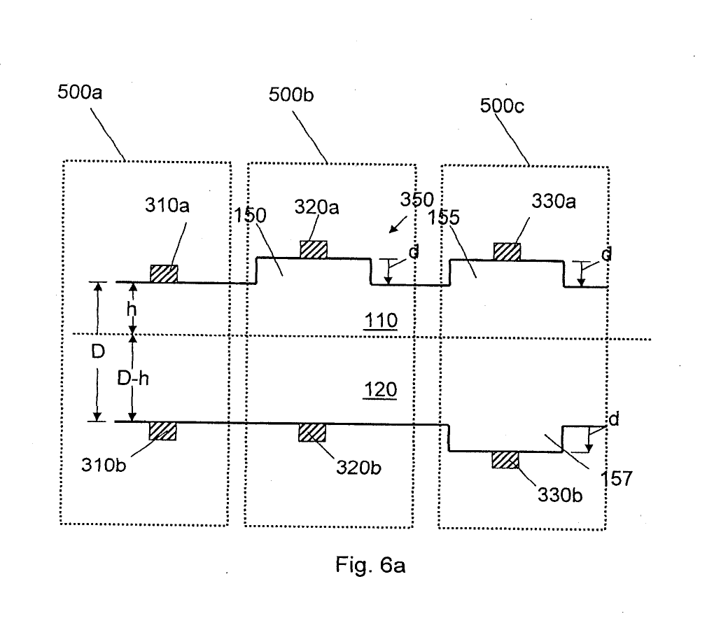

Consider FIG. 6a, which, by way of example, is similar to FIG. 5b. Here, there are shown three pairs of transmitters/receivers 500a, 500b, 500c. The first pair 500a relate to the first speed signal transmitter 310a and first speed signal receiver 310b. The second pair 500b relate to the second speed signal transmitter 320a and second speed signal receiver 320b. The third pair 500c relate to the third speed signal transmitter 310a and third speed signal receiver 310b.

A skilled reader will appreciate that any of these pairs 500a, 500b, 500c can be used to determine the location (or relative location) of the interface region 115 in a similar manner to that described in relation to FIG. 2. Similarly, and as is shown in FIG. 6b, pairs of horizontally displaced transmitters/receiver 500d, such as those provided by the first speed signal transmitter 310a and the second speed signal receiver 320b can be used to provide an advanced transmission path and/or a retarded transmission path.

In such arrangements, the apparatus 350, 360 is configured for one or more of the following: determining the static speed of signals (e.g. self calibrating for the medium to be determined); determining the location of the interface region; and determining the flow characteristics of the medium.

With regards to the embodiments shown in FIG. 6, it will readily be appreciated that one or more signals may be used for more than one purpose. For example, the time of flight of a speed signal may be additionally used as the time of flight of an interface signal. In the embodiments described in relation to FIG. 6, the signals and transmitters/receiver can be considered multi-purpose.

It will be appreciated that the embodiment of FIG. 6 may be provided with a flow meter, or may be a flow meter. The apparatus 350, 360 can measure flow characteristics of the medium, while also determining the location of the interface region and the static speed of signals in the first and second layer. Such an apparatus 350, 360 allows for continual monitoring of the flow (such as required by flow visualisation) and/or self-calibration (e.g. checking that the static speed is accurate).

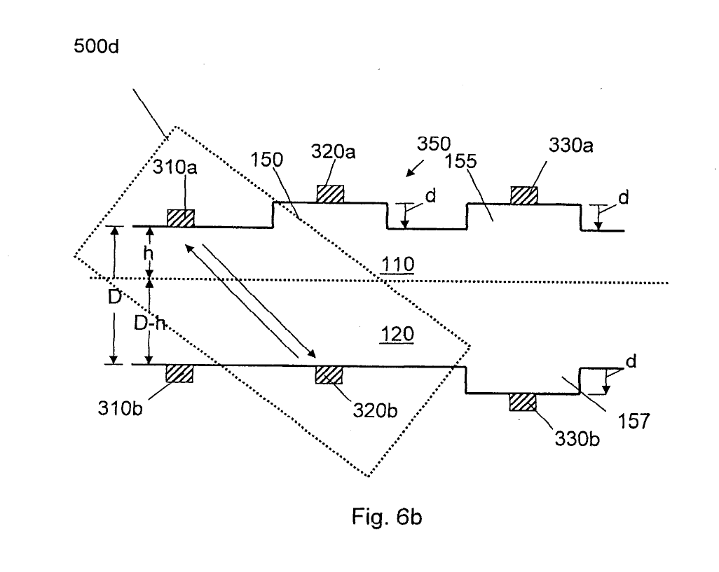

FIG. 7 shows an exemplary apparatus 900 similar to the apparatus 200, 250, 300, 400, 350, 360 described above, comprising a plurality of transmitters/receivers 910a-910n, 920a-920n for use with conduit 100. Again, each of the transmitters/receivers 910a-910n, 920a-920n are configured to transmit/receive a signals (e.g. advanced, retarded, interface, speed signals) across a first/second layer. It will be appreciated that the apparatus 900 may be configured with 2, 3, 4, 5, 10, 20 or more transmitters/receivers, or any number therebetween.

Here, the apparatus 900 further comprises a remote controller 930 comprising a processor 940 and a memory 950, the processor 940 and memory 950 being configured in a known manner. The processor/memory 940, 950 may be provided by a microcontroller, such that provided by a field programmable gate array, application specific integrated circuit, programmable intelligent computer, or the like. Here, the controller 930 is configured to operate the transmitter/receivers to as to provide the various signals. The controller 930 is further configured to determine the time of flight of such respective signals, and evaluate the flow characteristics of a medium (e.g. the flow rate, mass flow rate, etc.).

By being remote, the controller 930 is configured to communicate with the transmitters/receiver from a distance (i.e. not located at a multi-layer medium). In this embodiment, the controller 930 is configured to communicate with the respective transmitters/receivers by wired communication, but in alternative embodiments, the controller may be configured to communicate with the transmitters/receivers by wireless, optical, acoustic (i.e. using the layer in the conduit as a vehicle for signals) or any combination thereof.

The controller 930 comprise an output 960. The output 960 is configured to provide further apparatus, such as measuring apparatus, user interface (e.g. an output user interface) with data/information in relation to the flow characteristics of the medium. In some embodiments, the output 960 is configured to be in communication with a multiphase flow meter. Alternatively, the controller 930 and output 960 are comprised with a multiphase flow meter.

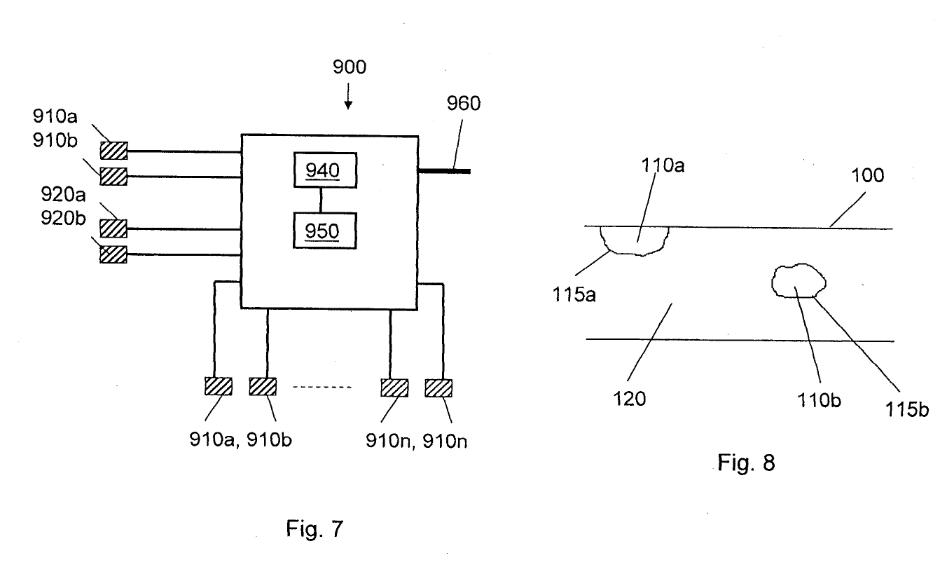

In the above described exemplary embodiments the first and second layers are shown to be continuously stratified. However, in alternative arrangements, as illustrated in FIG. 8, the first layer 110a may be at least partially contained within the second layer 120 with an interface region 115a defined therebetween. Further, the first layer 110b may be entirely contained within the second layer 120 with an interface region 115b defined therebetween.

While in the above exemplary embodiments, the apparatus/conduit is considered to have a wall of negligible thickness, or that the transmitters/receivers are in (direct) communication with the respective layer, it will be appreciated by the skilled reader that wall thickness, such as pipe thickness may easily be accounted for in any of the above embodiments (e.g. when the transmitters/receivers are not in direct communication with the layer).

For instance, consider the embodiment of FIG. 1, in which the first and second signal must travel through a conduit wall thickness of 1 mm. In such a configuration, the signal (first, second, etc.) must pass through this wall thickness twice in order to be passed initially into the layer, then again when being passed into the receiver (irrespective of whether or not a reflected signal is used)

In such an arrangement, by having knowledge of the conduit wall construction, for example, steel, and the wall thickness, the time taken for the signal to travel across the wall can be approximated/evaluated accounted for in any subsequent evaluation. In some embodiments, a temperature sensor, such as a thermocouple, may be provided with the conduit in order to determine accurately the speed of a signal in the wall.

Similarly, although in the above embodiments, layers such as oil and water have been described, it will readily be appreciated that the apparatus/method may be applicable for any layer, which may be a solid, liquid or a gas. For example, in some embodiments the apparatus may be configured to determine the flow characteristics in a combination of liquid and gas, such as oil and a hydrocarbon gas, or an emulsion of a number of fluids. In alternative embodiments, the apparatus may be configured to determine the flow characteristics in other mediums, such as coolants, or the like.

Although the first and second layers described above have been shown to have a direction of flow in the same direction, this is done for exemplary purposes only, and in alternative examples this need not be the case. Similarly, a skilled reader will appreciate that in some instances, the flow has a mean, or average flow, in a particular direction. In those cases, the determined flow characteristics may provide the mean flow rate, or the like. In addition, the angle of the advanced transmission path and retarded transmission path may be associated with the mean direction of flow of the first and/or second layer.

It will be appreciated that the above analysis may be used to determine the existence of deposition in a pipeline, or the like. For example, by determining that one of the first and second layers has no flow in a particular direction.

In addition, and in view of the foregoing description, it will be evident to a person skilled in the art that various modifications to any of the embodiments may be made within the scope of the invention. For example, any of the described embodiments may be provided such that they use reflected signals, which may be reflected from a conduit, or similar target, or the like. Similarly, the apparatus and/or methods disclosed may have other functions/steps, in addition to those described.

It will be appreciated to the skilled reader that the features of particular apparatus may be provided by apparatus arranged such that they become configured to carry out the desired operations only when enabled, e.g. switched on, or the like. In such cases, they may not necessarily have the appropriate software loaded into the active memory in the non-enabled state (e.g. switched off state) and only load the appropriate software in the enabled state (e.g. on state). The apparatus may comprise hardware circuitry and/or firmware. The apparatus may comprise software loaded onto memory. The apparatus may comprise a Field Programmable Gate Array, Application Specific Integrated Circuit, or the like. The apparatus may comprise electromagnetic transducers, acoustic transducers or the like.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

The present invention provides a robust method and apparatus for determining characteristics of a multi-layer medium while minimising complexities normally associated with known systems. For example, the present invention may permit direct evaluations of features or characteristics of the medium, such as static velocities, interface locations or the like. This may permit processing time to be significantly reduced which may in turn permit greater sampling rates to be used. This may permit advantageous effect of the present invention for use in real-time evaluation of the medium, such as real time flow visualisation.

While there have been shown and described and pointed out fundamental novel features of the invention as applied to preferred embodiments thereof, it will be understood that various omissions and substitutions and changes in the form and details of the devices and methods described may be made by those skilled in the art without departing from the scope of the invention.

1. A method for determining flow characteristics of a multi-layered medium, the medium having a first layer and second layer and an interface region defined between the first layer and the second layer, the method comprising:
using a time of flight of an advanced signal having been communicated across an advanced transmission path through the first and second layer and the time of flight of a retarded signal having been communicated across a retarded transmission path through the first and second layer, together with a static speed of the advanced signal and retarded signal in both the first and second layers and the location of the interface region along both the advanced and retarded transmission paths in order to determine the flow characteristics of the medium, the time of flight of the advanced signal and the time of flight of the retarded signal being influenced differently by the flow characteristics of the medium, wherein the determining of flow characteristics of the medium is performed using at least one processor.

2. A method according to claim 1, wherein the speed of the advanced signal has been increased due to the flow characteristics of the medium with respect to the static speed of the advanced signal and the speed of the retarded signal has been reduced due to the flow characteristics of the medium with respect to the static speed of the retarded signal.

3. The method according to claim 1, wherein the advanced transmission path and the retarded transmission path pass through substantially the same region of the medium.

4. The method according to claim 3, wherein the advanced transmission path and the retarded transmission path are the same, with the advanced signal communicated in one direction and the retarded signal communicated in the opposite direction.

5. (canceled)

6. The method according to claim 1 in which the advanced signal and retarded signal have been communicated at an oblique angle with respect to a direction of flow if the first layer and/or second layer.

7. (canceled)

8. The method according to claim 1, wherein the determined flow characteristic comprises one or more of: the first and/or second layer flow rate; the first and/or second layer direction of flow; the first and/or second layer volumetric flow rate; the first and/or second layer mass flow rate; the first and/or second layer bulk mass flow rate; the first and/or second layer slip conditions.

9. The method according to claim 1, wherein the determined flow characteristic provides for determining that one of the first and second layer has no flow rate or direction of flow.

10. (canceled)

11. The method according to claim 1, comprising determining, using at least one processor, the static speed of the advanced and/or retarded signal in one or both of the first and second layer.

12. The method according to claim 11, comprising determining the static speed of the advanced signal and/or retarded signal in at least one of the first and second layer by using a time of flight of a first speed signal having been communicated across a first known speed distance in the medium together with a time of flight of a second speed signal having been communicated across a second known speed distance in the medium, wherein the first known speed distance and the second known speed distance differ.

13. The method according to claim 12, wherein the signal species of the advanced signal and/or retarded signal, and first and second speed signals are the same so as to provide for determining the static speed of the advanced signal and/or the retarded signal in at least one of the first and second layer by using a determined static speed of the first and/or second speed signal.

14. The method according to claim 12, wherein the distance travelled by the first and second speed signals having been transmitted through one of the second and first layer is roughly the same, so as to provide for determining the static speed of the advanced and/or retarded signals through one of the first and second layer.

15-17. (canceled)

18. The method according to claim 11, wherein the determination of the static speed of one or both of the advanced and retarded signals allows for continuous calibration.

19. The method according to claim 1, wherein the method comprises determining, using a processor, the location of the interface region along the advanced transmission path and/or the retarded transmission path, and
using a time of flight of an interface signal having been communicated across an interface transmission path of known distance passing through the first layer, second layer and the interface region and using the time of flight of the interface signal together with the static speed of the interface signal in the first layer and the static speed of the interface signal in the second layer in order to provide for determining the location of the interface region along the interface transmission path, wherein the location of the interface region along one or both of the advanced transmission path and retarded transmission path is determinable from the location of the interface region along the interface transmission path.

20-23. (canceled)

24. The method according to claim 19, wherein a determined location of the interface region is used for determining the height, or hold-up, of at least one of the first and second layer.

25-27. (canceled)

28. The method according to claim 1, comprising using acoustic signals.

29-31. (canceled)

32. A method for determining flow characteristics of a multi-layered medium, the medium having a first layer and second layer and an interface region defined between the first and second layers, the method comprising:
communicating using a transmitter an advanced signal across an advanced transmission path through the first and second layer, and determining the time of flight;
communicating using a transmitter a retarded signal across a retarded transmission path through the first and second layer, and determining the time of flight, the time of flight of the advanced signal and the time of flight of the retarded signal being influenced differently by the flow characteristics of the medium;
using the determined time of flight of the advanced signal and the time of flight of the retarded signal together with a static speed of the advanced signal and retarded signal in both the first and second layers and the location of the interface region along both the advanced and retarded transmission paths in order to determine using a processor the flow characteristics of the medium.

33. Apparatus for determining flow characteristics of a multi-layered medium, such a medium having a first layer and second layer and an interface region defined between the first and second layers, the apparatus comprising a processor configured to use a time of flight of an advanced signal having been communicated across an advanced transmission path through the first and second layer and the time of flight of a retarded signal having been communicated across a retarded transmission path through a first and second layer, together with a static speed of an advanced signal and retarded signal in both first and second layers and a location of an interface region along both the advanced and retarded transmission paths in order to determine the flow characteristics of a medium, the time of flight of an advanced signal and the time of flight of a retarded signal being influenced differently by the flow characteristics of a medium.

34-38. (canceled)

39. The apparatus according to claim 33 comprising a first and second speed signal receiver, configured to receive a first and second speed signal having been communicating across a first and second known speed distance through a first and second layer in a medium, the first and second speed signal receivers configured to provide for determining the time of flight of a first and second speed signal, the apparatus configured to use a time of flight of a first speed signal, a second speed signal, and the first and second known speed distances in order to determine the speed of an advanced and/or retarded signal in one of a first and second layer.

40-44. (canceled)

45. A flow characterisation device, such as an oil and gas device, comprising apparatus according to claim 33.

46-47. (canceled)

48. A computer program, provided on a computer readable medium, the computer program configured to provide the method according to claim 1.

49-50. (canceled)
